(19) United States
(12) Patent Application Publication
(10) Pub. No.: US 2019/0351942 A1
(43) Pub. Date: Nov. 21, 2019

(54) TRACTION STEER COMPENSATION WITH STEERING TORQUE OVERLAY

(71) Applicant: GM Global Technology Operations LLC, Detroit, MI (US)

(72) Inventor: Gabriel de Paula Eduardo, Brighton, MI (US)

(21) Appl. No.: 15/984,830

(22) Filed: May 21, 2018

(51) Int. Cl. B62D 6/00; B62D 15/02; B62D 5/04

(52) U.S. Cl. CPC B62D 6/003; B62D 15/025; B62D 5/0463; B62D 15/021

(57) ABSTRACT

A system correcting for a traction steer event includes a steering wheel angle entered into a steering wheel angle function to identify a steering wheel angle gain. A steering wheel velocity is entered into a steering wheel velocity function to identify a steering wheel velocity gain. A vehicle speed is entered into a vehicle speed function to identify a vehicle speed gain. A propulsion motor torque is entered into a motor torque function to identify a propulsion motor torque gain. A vehicle yaw rate is entered into a yaw rate function to identify a yaw rate gain. The gains are all multiplied to obtain a final gain. The final gain is submitted to a control module which determines a steering torque overlay required to adjust a torque output from an electric power steering motor.

### INTRODUCTION

The present disclosure relates to automobile vehicle steering systems.

Transmission differentials in front wheel drive vehicles allow a torque bias between the left and right sides to cause different left and right traction forces generated at a tire-to-road interface. A typical open differential supplies unequal torque to the driven wheel because of internal friction. Torque is normally biased to the slower rotating wheel. A torque bias of 10-20% of a total torque is considered normal, however, torque bias creates unbalanced kingpin steering moments that when combined result in steering disturbance effects that can be felt by the vehicle operator as a steering effort drop, a steering wheel pull or a traction steer event.

Traction steer is an unintended steer event resulting from an inequality between tractive forces on the front tires, occurring most frequently under high drive torques, for example when accelerating in a turn. Drive torque tends to pull the vehicle and the steering wheel toward an inside of a turn due to uneven left-versus-right tire tractive forces. It also occurs during acceleration in a straight line on uneven roads if the steering wheel is alternately pulled left and right due to rapidly changing tire loads, resulting in rapidly changing tractive force. Drive torque is reacted as a force on a spindle, generating a kingpin moment that is proportional to a tractive force and a spindle length. As drive torque and tire longitudinal slip increase, tire restoring moments are reduced, making the phenomenon more evident. In addition, the prompt and high torque delivery provided by the electric drive motors of electric powered vehicles makes the effect more pronounced.

Thus, while current automobile vehicle steering systems achieve their intended purpose, there is a need for a new and improved system and method to compensate steering disturbance effects from different left and right traction forces generated at the tire-to-road interface in front wheel drive vehicles.

### SUMMARY

According to several aspects, a system for correcting for a traction steer event of a front wheel drive vehicle using a steering torque overlay includes a gain value determined for each of a steering wheel angle, a steering wheel velocity, a vehicle speed, a propulsion motor torque and a vehicle yaw rate. A steering torque overlay is defined by a combination of all of the gain values. An electric power steering motor torque output is modified using the steering torque overlay.

In another aspect of the present disclosure, a steering wheel angle function is entered with the steering wheel angle to identify the steering wheel angle gain.

In another aspect of the present disclosure, a steering wheel velocity function is entered with the steering wheel velocity to identify the steering wheel velocity gain.

In another aspect of the present disclosure, a vehicle speed function is entered with the vehicle speed to identify the vehicle speed gain.

In another aspect of the present disclosure, a motor torque function is entered with the propulsion motor torque to identify the propulsion motor torque gain.

In another aspect of the present disclosure, a yaw rate function is entered with the vehicle yaw rate to identify the yaw rate gain.

In another aspect of the present disclosure, an electric power steering control module is configured to receive a request to apply the steering torque overlay, the electric power steering control module prioritizing the request and sending the steering torque overlay to an electric power steering motor.

In another aspect of the present disclosure, a wheel velocity gain value determined for a wheel velocity is calculated from an output from a left wheel velocity sensor and a right wheel velocity sensor.

In another aspect of the present disclosure, the output from the left wheel velocity sensor and the right wheel velocity sensor are combined and converted to an absolute value in a modifier prior to being entered into a wheel velocity function.

In another aspect of the present disclosure, a shape of a non-linear function defining each of the functions are tuned for an individual vehicle and drive train.

According to several aspects, a system for correcting for a traction steer event of a front wheel drive vehicle using a steering torque overlay includes a steering wheel angle entered into a steering wheel angle function to identify a steering wheel angle gain. A steering wheel velocity is entered into a steering wheel velocity function to identify a steering wheel velocity gain. A vehicle speed is entered into a vehicle speed function to identify a vehicle speed gain. A propulsion motor torque is entered into a motor torque function to identify a propulsion motor torque gain. A vehicle yaw rate is entered into a yaw rate function to identify a yaw rate gain. The steering wheel angle gain, the steering wheel velocity gain, the vehicle speed gain, the propulsion motor torque gain and the yaw rate gain being combined to obtain a final gain. The final gain is submitted to a control module which determines a steering torque overlay applied to adjust a torque output from an electric power steering motor.

In another aspect of the present disclosure, the steering torque overlay compensates steering disturbance effects from different left and right tire traction forces generated at a tire to road surface interface in a front wheel drive vehicle.

In another aspect of the present disclosure, a throttle position, a transmission torque, and a vehicle lateral acceleration each entered into a function to obtain a throttle position gain, a transmission torque gain and a vehicle lateral acceleration gain entered into the determination of the final gain.

In another aspect of the present disclosure, if a traction steer event is identified to be occurring, a determination is made if sufficient steering motor current is available to compensate for the traction steer event, and if so a torque signal change as the steering torque overlay is sent to a steering motor.

In another aspect of the present disclosure, a gain multiplier receives each gain, the gain multiplier multiplying all of the gains to obtain the final gain.

In another aspect of the present disclosure, a wheel velocity determined from a left wheel velocity sensor and a right wheel velocity sensor are combined and converted to an absolute value in a modifier.

In another aspect of the present disclosure, an output from the modifier is entered into a wheel velocity function to generate a gain for wheel velocity which is passed to the gain multiplier.

According to several aspects, a method for correcting for a traction steer event using a steering torque overlay includes: identifying a traction steer event resulting from different left and right tire traction forces in a vehicle; determining a gain for each of a steering wheel angle, a steering wheel velocity, a vehicle speed, a propulsion motor torque and a vehicle yaw rate; calculating a steering torque overlay by multiplying all of the gains; entering the steering torque overlay into a control module; and adjusting a torque output from an electric power steering motor using a signal from the control module.

In another aspect of the present disclosure, the method includes entering each of a steering wheel angle function, a steering wheel velocity function, a vehicle speed function, a motor torque function and a yaw rate function prior to the calculating step to identify the gain for each of the steering wheel angle, the steering wheel velocity, the vehicle speed, the propulsion motor torque and the vehicle yaw rate.

In another aspect of the present disclosure, the method includes identifying an available current for an electric power steering motor prior to the adjusting step to identify if the available current is operable to perform the adjusting step.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagram of a traction steer compensation with steering overlay system according to an exemplary embodiment;

FIG. 2 is a flow diagram of the system of FIG. 1; and

FIG. 3 is a graph of exemplary steering torque responses with and without correction using the system of FIG. 1.

### DETAILED DESCRIPTION

The following description is merely exemplary in nature and is not intended to limit the present disclosure, application, or uses.

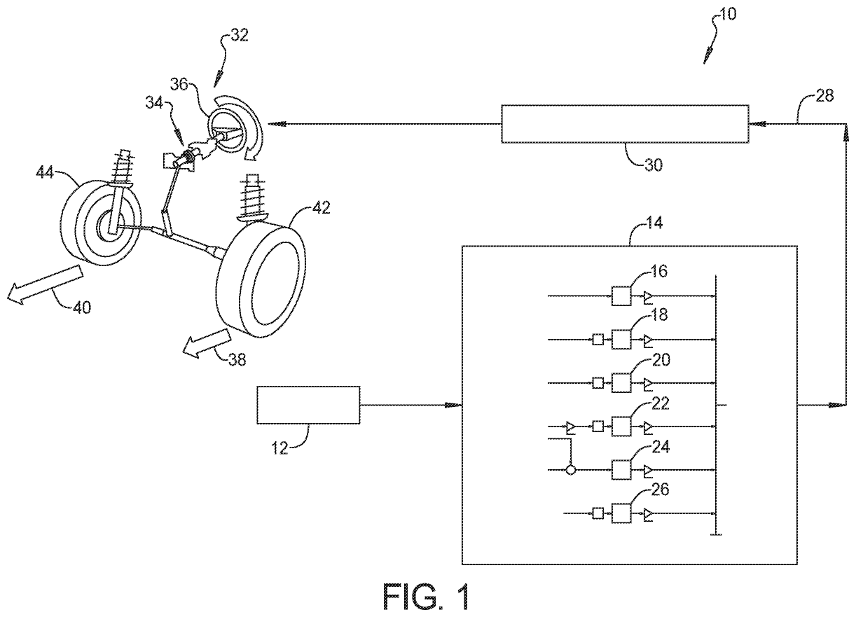

Referring to FIG. 1, a traction steer compensation with steering torque overlay system 10 uses multiple vehicle signals 12 which are input as variables into a tunable function 14. The traction steer compensation with steering torque overlay system 10 generates a steering torque overlay used to compensate steering disturbance effects from different left and right tire traction forces generated at a tire to road surface interface in front wheel drive vehicles. The variables used as the multiple vehicle signals 12 include a steering wheel angle (SWA) 16, a steering wheel velocity (SWV) 18, a vehicle speed (Vx) 20, a propulsion motor torque (Tq) 22, a wheel differential speed 24, and a vehicle yaw rate 26. Additional variables that can be included with the tunable function 14 include a throttle position, a transmission torque, and a vehicle lateral acceleration.

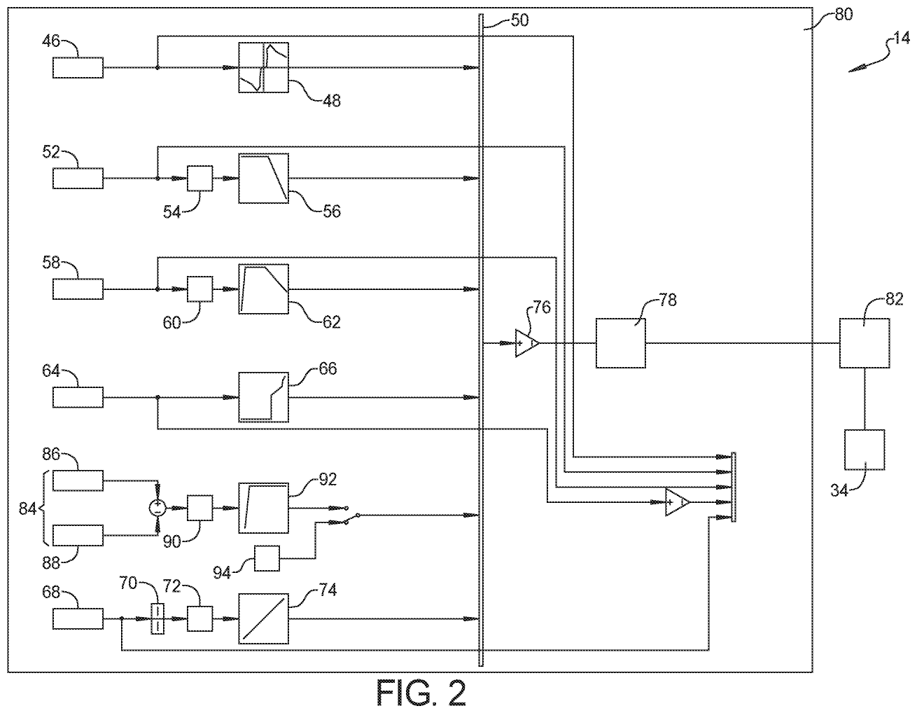

The steering wheel angle (SWA) 16 is a sensed value received from a steering wheel angle sensor. The steering wheel velocity (SWV) 18 in degrees per second is calculated from the SWA 16. The vehicle speed (Vx) 20 in kilometers per hour is calculated from measured wheel speeds. The propulsion motor torque Tq 22 in newton meters is a calculated value. The wheel differential speed 24 is calculated from a sensed wheel speed difference (left wheel speed minus a right wheel speed) and is converted to an absolute value because the left and right wheel speeds will continuously vary depending if the vehicle is traveling straight or is in a left or a right hand turn. The vehicle yaw rate 26 in degrees per second is a sensed value based on the output of a yaw rate sensor. A gain is determined and applied to each of the above values as will be described in greater detail in reference to FIG. 2.

An output 28 from the tunable function 14 is used to calculate a steering torque overlay 30. The steering torque overlay 30 is forwarded to a steering control system 32 of a front wheel drive vehicle. The steering torque overlay 30 is applied as a torque modification in an electric power steering motor 34 to compensate for disturbance effects at a steering wheel 36 created from different left and right traction forces 38, 40 generated at a tire to road interface of each of a left side tire 42 and a right side tire 44.

Referring to FIG. 2 and again to FIG. 1, the algorithm for the tunable function 14 of the traction steer compensation with steering torque overlay system 10 functions as follows. The output from all of the sensors and the calculated values used as inputs are individually entered. Absolute values are applied for several of the inputs. Each input is then compared to data in one of multiple functions which may be obtained in one or more lookup tables each defining a range of values for one of the inputs. A gain is assigned to each of the inputs using the functions. All of the gains from each of the inputs are multiplied to determine a final gain. The final gain is entered into the module of a computer or processor as a request for steering torque compensation which is prioritized along with gains and other steering torque inputs received by the steering system.

As previously noted, traction steer is an unintended steer event resulting from an inequality between tractive forces on the front tires, occurring most frequently under high drive torques, for example when accelerating in a turn. A traction steer event occurs when tractive forces influence the moment applied to the steering wheel 36 for example when a driven torque is greater on the left or right tire. If a traction steer event is identified to be occurring, a torque signal change as the steering torque overlay 30 is sent to the electric power steering motor 34.

According to several aspects, as a minimum the following five items are input as variables to calculate the tunable function 14.
1) The sensed value of the SWA 16 in degrees received from a steering wheel angle sensor 46 is entered into a steering wheel angle function 48, and a steering wheel angle gain is determined which is passed to a gain multiplier 50.
2) The steering wheel velocity (SWV) 18 in degrees per second is calculated using the SWA 16 in degrees over a time in seconds in a calculation block 52 and converted to an absolute value in a modifier 54 prior to being entered into a steering wheel velocity function 56. From the steering wheel velocity function 56 a gain for steering wheel velocity is determined which is passed to the gain multiplier 50.
3) The vehicle speed (Vx) 20 in kilometers per hour is calculated from the different measured wheel speeds in a calculation block 58 and converted to an absolute value in a modifier 60 prior to being entered into a vehicle speed function 62. From the vehicle speed function 56 a gain for vehicle speed is determined which is passed to the gain multiplier 50.
4) The sensed value of the actual propulsion motor torque (Tq) 22 received from an electric power steering motor torque sensor 64 is entered into an electric power steering motor torque function 66, and an electric power steering motor torque gain is determined which is passed to the gain multiplier 50.
5) The vehicle yaw rate 26 in degrees per second is received from a yaw rate sensor 68 and is first passed through a filter 70 and then converted to an absolute value in a modifier 72 prior to being entered into a yaw rate function 74. From the yaw rate function 74 a gain for yaw rate is determined which is passed to the gain multiplier 50.

The gains from each of the above 5 items defined by the steering wheel angle, the steering wheel velocity, the vehicle speed, the electric power steering motor torque, and the vehicle yaw rate are combined for example by multiplying the gains in the gain multiplier 50 to produce a final gain 76. The final gain 76 defines a steering torque change request 78 which is sent from an electronic brake control module (EBCM) 80 where the algorithm resides to an electronic power steering (EPS) module 82 via a CAN bus and is applied as a torque modification in the electric power steering motor 34. The final gain 76 values are tunable during system development, and thereafter no further processing should be required. The algorithm is also tuned using those non-linear functions that have a trigger capability.

The EPS module 82 prioritizes torque change requests together with all of the steering system torque and related traction control requests in the system. A priority or authority identified for the final gain 76 in the EPS module 82 is defined based on a series of system procedures. It is anticipated that for a majority of traction steer events, there will be no restriction on the EPS module 82 to respond to the EBCM 78 request to institute a steering torque change request.

The initial shapes of the non-linear functions that define the values in the lookup tables or functions 48, 56, 62, 66 and 74 are based on the number of occurrences and system conditions during the traction steer events for each vehicle and each different drive train. For example, if the traction steer events occur only at high engine torque demand, then the non-linear functions will be proportional to the torque demand. Once the shapes of each of the non-linear functions identifying the function values obtained for example from the lookup tables are defined, the values can be further refined using in-vehicle or CAE tuning. The non-linear functions defining each of the function values are therefore tuned or modified to incorporate the differences between each different vehicle drive train the tunable function 14 is used on, for example to differentiate different vehicle drive torque, braking system criteria, wheel speeds, and the like.

In addition to the five items used as input variables for the algorithm to calculate the tunable function 14 discussed above, the algorithm for the tunable function 14 can also include a wheel velocity 84 which is determined from a left wheel velocity sensor 86 and a right wheel velocity sensor 88, whose outputs are combined and converted to an absolute value in a modifier 90 prior to being entered into a wheel velocity function 92. From the wheel velocity function 92 a gain for wheel velocity 94 is determined which is passed to the gain multiplier 50. Additional variables for the algorithm to calculate the tunable function 14 can also include throttle position, transmission torque, and vehicle lateral acceleration. A dedicated function is provided for each variable to identify a gain associated with each variable.

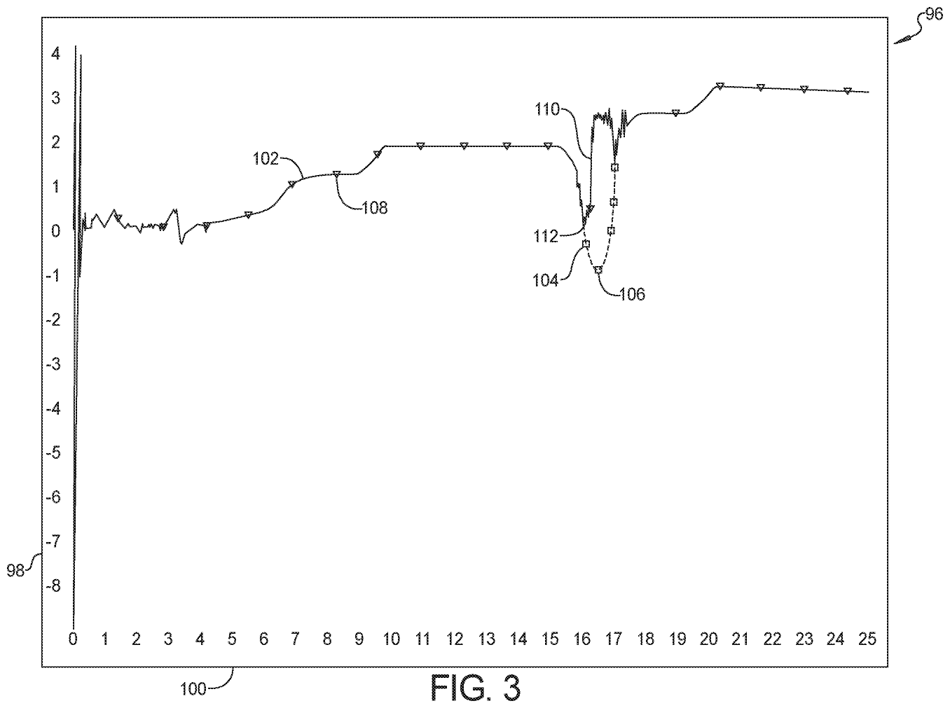

Referring to FIG. 3 and again to FIGS. 1 through 2, a graph 96 identifies multiple steering wheel torque values 98 in newton-meters over a time 100 in seconds. A first curve 102 represents a system experiencing a traction steer event which is not corrected using the tunable function 14 of the present disclosure. A torque deviation portion 104 of the first curve 102 identifies a maximum steering wheel torque deviation 106 occurs at approximately 16 seconds. A second curve 108 substantially overlaps the torque values of the first curve 102 until a torque deviation portion 110 occurs. By employing the tunable function 14 to reduce an excess torque of the steering system a maximum steering wheel torque deviation 112 of the second curve 108 during conditions representing the same traction steer event is reduced from the maximum steering wheel torque deviation 106 in the uncorrected system. In the example shown, an approximate 40% reduction in steering torque deviation is achieved, however, the correction or reduction in steering torque deviation provided by the traction steer compensation with steering torque overlay system 10 can vary in range and is expected to be less than 100%.

The traction steer compensation with steering torque overlay system 10 of the present disclosure is not relied on to offset 100% of the torque deviation occurring during a traction steer event for several reasons. If a gain output from the traction steer compensation with steering torque overlay system 10 is submitted to the EBCM 78 and from the EBCM 78 via the CAN bus 80 to the EPS module 82. The EPS module 82 prioritizes the request to modify electric power steering motor torque with all of the steering system torque and related traction control requests in the system.

A traction steer compensation with steering overlay system of the present disclosure offers several advantages. These include provision of an algorithm for determining a steering torque overlay which is applied as a torque modification in a power steering assist motor to compensate for disturbance effects at a steering wheel created from different left and right traction forces generated at a tire to road interface of each of a left side tire and a right side tire. An output from a tunable function acquiring data from multiple functions is used to calculate the steering torque overlay. The steering torque overlay is forwarded to a steering control system of a front wheel drive vehicle.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for correcting for a traction steer event of a front wheel drive vehicle using a steering torque overlay, comprising:
a gain value determined for each of a steering wheel angle, a steering wheel velocity, a vehicle speed, a propulsion motor torque and a vehicle yaw rate;
a steering torque overlay defining a combination of all of the gain values; and
an electric power steering motor torque output modified using the steering torque overlay.

2. The system of claim 1, further including a steering wheel angle function entered with the steering wheel angle to identify the steering wheel angle gain.

3. The system of claim 2, further including a steering wheel velocity function entered with the steering wheel velocity to identify the steering wheel velocity gain.

4. The system of claim 3, further including a vehicle speed function entered with the vehicle speed to identify the vehicle speed gain.

5. The system of claim 4, further including a motor torque function entered with the propulsion motor torque to identify the propulsion motor torque gain.

6. The system of claim 5, further including a yaw rate function entered with the vehicle yaw rate to identify the yaw rate gain.

7. The system of claim 1, further including a control module configured to receive a request to apply the steering torque overlay, the control module prioritizing the request and sending the steering torque overlay to an electric power steering motor.

8. The system claim 1, further including a wheel velocity gain value determined for a wheel velocity is calculated from an output from a left wheel velocity sensor and a right wheel velocity sensor.

9. The system of claim 8, wherein the output from the left wheel velocity sensor and the right wheel velocity sensor are combined and converted to an absolute value in a modifier prior to being entered into a wheel velocity function.

10. The system of claim 6, wherein a shape of a non-linear function defining each of the functions are tuned for an individual vehicle drive train.

11. A system for correcting for a traction steer event of a front wheel drive vehicle using a steering torque overlay, comprising:
a steering wheel angle entered into a steering wheel angle function to identify a steering wheel angle gain;
a steering wheel velocity entered into a steering wheel velocity function to identify a steering wheel velocity gain;
a vehicle speed entered into a vehicle speed function to identify a vehicle speed gain;
a propulsion motor torque entered into a motor torque function to identify a propulsion motor torque gain;
a vehicle yaw rate entered into a yaw rate function to identify a yaw rate gain;
a final gain obtained by multiplying the steering wheel angle gain, the steering wheel velocity gain, the vehicle speed gain, the propulsion motor torque gain and the yaw rate gain; and
a control module receiving the final gain, the control module determining a steering torque overlay applied to adjust a torque output from an electric power steering motor.

12. The system of claim 11, wherein the steering torque overlay compensates a steering disturbance effect created by different left and right tire traction forces generated at a tire to road surface interface in a front wheel drive vehicle.

13. The system of claim 11, further including a throttle position, a transmission torque, and a vehicle lateral acceleration each entered into a function to obtain a throttle position gain, a transmission torque gain and a vehicle lateral acceleration gain entered into the determination of the final gain.

14. The system of claim 11, wherein if a traction steer event is identified to be occurring, a determination is made if sufficient steering motor current is available to compensate for the traction steer event, and if so a torque signal change as the steering torque overlay is sent to a steering motor.

15. The system of claim 11, further including a gain multiplier receiving each gain, the gain multiplier multiplying all of the gains to obtain the final gain.

16. The system of claim 15, further including a wheel velocity determined from a left wheel velocity sensor and a right wheel velocity sensor whose outputs are combined and converted to an absolute value in a modifier.

17. The system of claim 16, wherein an output from the modifier is entered into a wheel velocity function to generate a gain for wheel velocity which is passed to the gain multiplier.

18. A method for correcting for a traction steer event using a steering torque overlay, comprising:
identifying a traction steer event resulting from different left and right tire traction forces in a vehicle;
determining a gain for each of a steering wheel angle, a steering wheel velocity, a vehicle speed, a propulsion motor torque and a vehicle yaw rate;
calculating a steering torque overlay by multiplying all of the gains;
entering the steering torque overlay into a control module; and
adjusting a torque output from an electric power steering motor using a signal from the control module.

19. The method for correcting for a traction steer event using a steering overlay of claim 18, further comprising entering each of a steering wheel angle function, a steering wheel velocity function, a vehicle speed function, a motor torque function and a yaw rate function prior to the calculating step to identify the gain for each of the steering wheel angle, the steering wheel velocity, the vehicle speed, the propulsion motor torque and the vehicle yaw rate.

20. The method for correcting for a traction steer event using a steering overlay of claim 18, further comprising identifying an available current for an electric power steering motor prior to the adjusting step to identify if the available current is operable to perform the adjusting step.
